(19) United States
(12) Patent Application Publication
(10) Pub. No.: US 2016/0063824 A1
(43) Pub. Date: Mar. 3, 2016

(54) EMERGENCY FLASHING LIGHT SYSTEM

(71) Applicant: Paul Fiore, Gainesville, FL (US)

(72) Inventor: Paul Fiore, Gainesville, FL (US)

(21) Appl. No.: 14/813,823

(22) Filed: Jul. 30, 2015

Related U.S. Application Data
(60) Provisional application No. 62/042,109, filed on Aug. 26, 2014.

(51) Int. Cl. G08B 5/38

(52) U.S. Cl. CPC G08B 5/38

(57) ABSTRACT

A light flashing system is provided that fits over an existing conventional light switch in order to convert the conventional light switch into a remotely controlled light switch providing repeated, flashing, operation of an associated light. Manual operation is also a possible. The system provides emergency flashing operation of a residence external light through remote initiation of a user.

### FIELD OF INVENTION

The present invention is in the field of electrical devices for controlling light switches. More particularly, the invention pertains to electrical devices for attaching to existing light switches to allow the light switch to be remotely actuated and function as a flashing light for alerting individuals.

### BACKGROUND

When first responders such as emergency medical personnel, police, or firefighters are responding to an emergency distress call, it is important for them to locate the residence where the distress call came from quickly. In most cases it remains difficult to locate a particular residence because of hard to read or missing house numbers. Moreover, even with advances in GPS technology, it remains difficult to locate a residence at night and in rural areas. Thus there exists a need for a way to assist emergency responders to pinpoint a house which has asked for emergency assistance.

Several human monitoring or geriatric monitoring services, such as that marketed under the trademark “Life Alert” owned by Life Alert Emergency Response, Inc. of California, U.S., are used by many handicapped and senior citizens who depend on the service to notify the appropriate emergency responders when the person is in need of assistance. While many of these systems alert authorities of a person's need for assistance, and even provide information of the person's location, such systems do not include any feature for alerting first responders to the physical residence, thus usually creating delay in providing assistance. Thus, these services often fail at providing assistance to those responding to the physical residence where assistance is sought.

Notwithstanding, while emergency services may be able to contact first responders, nothing is done to potentially alert neighbors that someone may be in trouble. While it is appreciated that emergency services may be able to respond fairly quickly, delays may occur, or an individual needing assistance may need immediate intervention which first responders may be slow to provide. Thus there remains an unmet need for emergency service to have the ability to locate neighbors or passersby that a home occupant is in distress.

In addition to emergencies, delivery services have also identified the need for a device to assist the delivery service in locating a particular house. For example, pizza delivery services often encounter similar issues in finding a person's home in the evening due to the inability of GPS to exactly resolve an address and poorly lit house numbers. Thus, there further exists a need for a device which can also alert delivery men that a person is expecting to receive a delivery.

Several flashing light switch controllers are also known in the art, such as in U.S. Pat. No. 5,406,129, but these are limited in having to be activated manually. Moreover, many of these flashing devices require the existing light switch to be fully removed in order for the flashing switch to be wired into a home lighting system. Thus, these systems do not allow for the surface mounting of a flasher over an existing switch, rather the flashers known in the art require the use of a skilled electrician to install.

Thus there remains an unmet need for a flashing device to provide assistance to first responders in finding a person home who has signaled for assistance, or to alert neighbors or passersby that someone is having an emergency. There also exists a need for notifying non-emergency personnel where a home may be located for deliveries and the like. There further remains an unmet need for a flashing device that is easy to install and does not require the assistance of a skilled electrician. Finally, there remains an unmet need for a device that can interface with an existing home or human monitoring system. No device exists which solves any or all of these unmet needs.

### SUMMARY OF THE INVENTION

The present invention is a light flashing system that fits over an existing light switch in order to convert a conventional light switch into a manually operated or remotely controlled light switch providing repeated, flashing, operation of an associated lighting device. The invention includes improved lighting switch systems that including conventional remote signaling and control elements.

In one embodiment, the system includes a rigid housing configured to be secured over a conventional wall-mounted electrical switch that includes a rigid toggle actuator. A switching system within the housing mechanically engages with the actuator of the wall-mounted switch, such that operation of the switching system functions to operate the wall-mounted switch in repeated “on” and “off” conditions. The housing also contains a communication system enables control and operation of the switching system from remote locations, such as by a distant human user. A power supply is provided in the housing to power both the switching system and communication system.

While the inventive system may include a manual initiation switch, preferably the communication system if the invention enables communicates with one or more remote controlling devices, including optionally conventional wireless signaling systems, to enable operation of the lighting device.

The design of the inventive system enables installation and operation in conjunction with a previously installed wall-mounted lighting switch without interaction with electrical components of the lighting switch or system.

In various alternative configurations, the switching system includes any of various different mechanical devices to engage the switching elements of the associated wall-mounted lighting switch, depending on the design and operation of the lighting switch. The invention includes methods of controlling a lighting device in the manner described. Additional aspects of the inventive design are presented through the below description of detailed embodiments and the associated figures.

### BRIEF DESCRIPTION OF THE DRAWINGS

FIG. 1 illustrates a prior art electric wall switch.

FIG. 2 illustrates a switch device according to the invention mounted over a conventional wall switch.

FIG. 3 is a side section view of the embodiment of FIG. 2 and including a remote control device.

### DETAILED DESCRIPTION OF EMBODIMENTS OF THE INVENTION

The present invention is directed to a light flashing system that fits over an existing light switch in order to convert a conventional light switch into a manually operated or remotely controlled light switch enabling flashing operation of a connected lighting device.

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The present invention contains the features of a device for the ad hoc conversion of a light switch to a flashing light system. The device includes a housing for mounting atop, covering, an existing light switch. The housing contains a switching system for actuating the light switch, alternately and repeatedly, to the “on” and “off” positions of the light switch, a communication system for communicating with a remote control device or remote emergency indication system, and a power supply for powering the switching system and said communication system. In at least one embodiment of the invention, the communication system receives a signal from a remote control device or remote emergency indication system to actuate the switching system, and the switching system actuates the light switch alternately between the “on” and “off” positions at a particular actuating frequency until the remote control device or remote indication systems sends a signal to the communication system to halt the switching system.

The housing system is intended to have the ability to be adapted to the exterior of an existing light switch. Nothing herein is intended to limit the type of switch which the housing may be adapted to. Moreover it is appreciated that the switch construction and design may any one of a variety of existing and future alternatives, including, for example, rocker, decora or toggle type light switch, and it is appreciated that variances in the housing construction is known in the art for the housing to be adapted to these differing switch types.

The housing system is further intended to contain the switching system, the communication system, and the power supply to allow for the switching operation of the switch. The housing may have many of a variety of different shapes and sizes, and nothing herein is intended to limit the shape and size of the housing. In at least one embodiment, the housing is a rectangular box having a front side, a back side, and four closed sides. In at least one embodiment the backside has at least one opening for fitting over an existing light switch with sufficient space for the light switch actuator to travel to the “on” and “off” positions within the housing. In at least one embodiment, the housing includes a cover plate for securing the cover plate to the housing to close the housing. The housing may be constructed of any material known in the art such as plastic, polyvinylchloride (PVC), or metal.

The housing is intended to be mounted to the existing light switch with little to no installation. In at least one embodiment, the housing includes a mounting system for mounting the housing to a conventional light switch wall plate. In some embodiments, the mounting system includes at least one hole in the back side of the housing for the housing to be connected to the existing switch or switch plate. Most conventional light switches are made substantially of metal which have the ability of attracting and adhering magnets. In other embodiments, the mounting system includes at least one magnet for securing the housing to the light switch. It is further appreciated that some light switches may be difficult to secure a housing to with a screw or magnet, thus in at least one other embodiment, the mounting system includes at least one adhesive portion for securing the housing to the light switch or light switch plate.

When a cover plate is secured to the front side of the housing to contain the communication system, the switching system and the power supply within the housing, in some embodiments the housing cover is a flat plate, while in other embodiment the housing cover has an ornamental feature. It is appreciated that some switch functionality may be included. In at least one embodiment, the cover plate of the housing includes a switch allowing for the manual activation or deactivation of the switching system. In at least one embodiment, the housing contains a switch for the manual operation or the manual override of the switching system. In at least one embodiment, the manual operation switch or the switch for controlling frequency is located on any exterior wall of the housing.

The present invention provides for a switching system for actuating a light switch alternately and periodically in continuous fashion to its respective “on” and “off” positions. The switching system received a signal from the communication system to perform its function of toggling the light switch which the housing has been installed over. The switching system of the inventive device includes a switching mechanism and a switching circuit for operating the switching mechanism. It is intended that the switching circuit controls electrical signals to activate the switching mechanism which operates the light switch repeatedly and periodically, toggling the light switch between the “on” and “off” positions. In at least one embodiment, the switching circuit alternates an electrical signal at an actuating frequency to cause the switching mechanism to toggle the light switch at that particular actuating frequency. In at least one embodiment, the housing includes a switch for adjusting the actuating frequency of the switching circuit.

One of several different switching mechanisms may be used based on the type of light switch is used. It is appreciated that depending on the type of light switch, that the switching mechanism will need to correspond to that type of light switch. In at least one embodiment, the switching mechanism is at least two magnets which are repeatedly and alternately repositioned to toggle the light switch to the “on” and “off” positions at the actuating frequency. In at least one embodiment, a plurality of magnets are used to toggle the light switch between the “on” and “off” positions. In some embodiments, the magnets are electro-magnets for actuating the light switch toggle to the on and off positions. In other embodiments, the switching mechanism is one or more levers which physically operate the switch between the “on” and “off” positions, while in other embodiments the switching mechanism is a mechanical actuator for actuating the light switch toggle to the “on” and “off” positions. Certain embodiments provide a manually activated switching mechanism such that the light switch may be operated to an “on” or “off” position without activating the switching system or without overriding the switching system.

In at least one embodiment, the actuating frequency of the switching system is pre-programmed into the switching system, communicated from the remote control device, manually controlled on a frequency control switch further included in the switching system, or any combination thereof.

A communication system is used for the communication of a signal from a remote device or a remote emergency system to activate the switching system. The communication system is powered by the power supply, and upon receiving communication from a remote device or remote emergency system, provides a signal to the switching system to toggle the light switch at the actuating frequency of the switching system. In at least one embodiment the communication system is a receiver for receiving radio, Bluetooth (trademark of Bluetooth Sig, Inc.), Wi-Fi, cellular, or other wireless communication known in the art. In at least one embodiment, the communication system receives a signal from a remote control device. In some embodiments, the remote control device is an alarm system, an emergency monitoring system, a geriatric monitoring system, a human assistance monitoring system, a manually operated remote control, or any combination thereof. In at least one variation, the remote control device is an alarm system, an emergency monitoring system, a geriatric monitoring system, a human assistance monitoring system, a manually operated remote control, or any combination thereof.

A power supply is included in the housing to provide power to the communication system and the switching system. It is intended than any small portable power supply known in the art may be suitable for a power supply in the inventive system. Without limiting the invention to any particular power supply, in at least one embodiment, the power supply is a battery, capacitor, or any combination thereof. In some embodiments the power supply is removable for charging or replacement. In other embodiments, the power supply is an electrical connection between the housing and the power being received at the light switch.

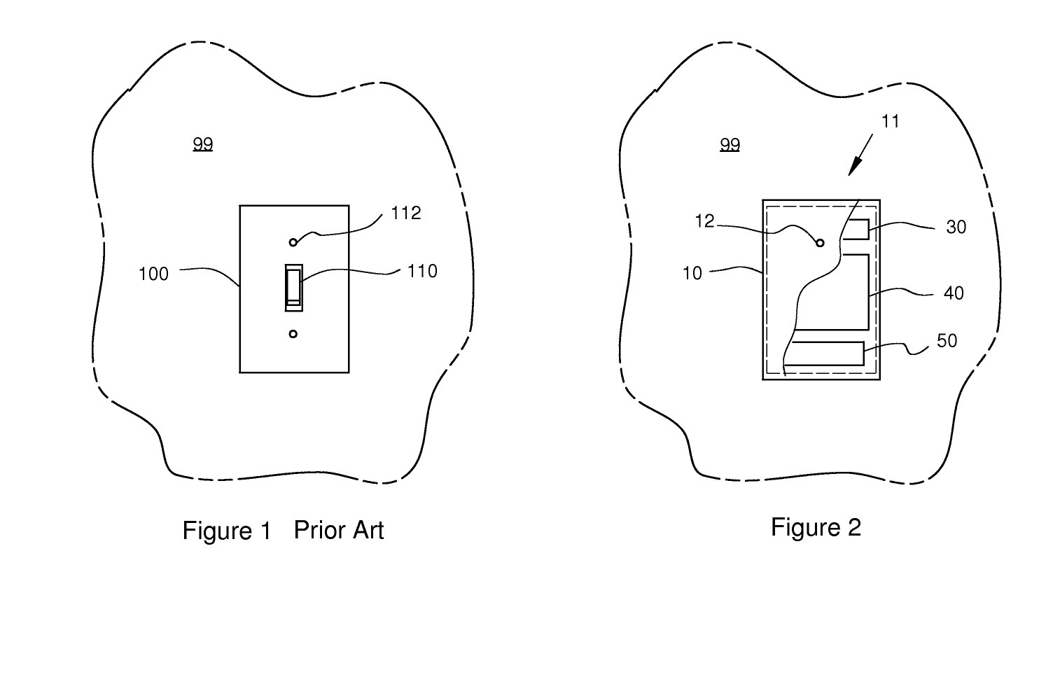

FIG. 1 depicts a conventional prior art wall-mounted electrical switch mounted on a convention building wall 99 and including a mechanical actuator in the form of a rigid toggle switch lever 110 for reference herein. Typically, a prior art electrical switch includes a cover plate 105 that is secured by two threaded fasteners 112.

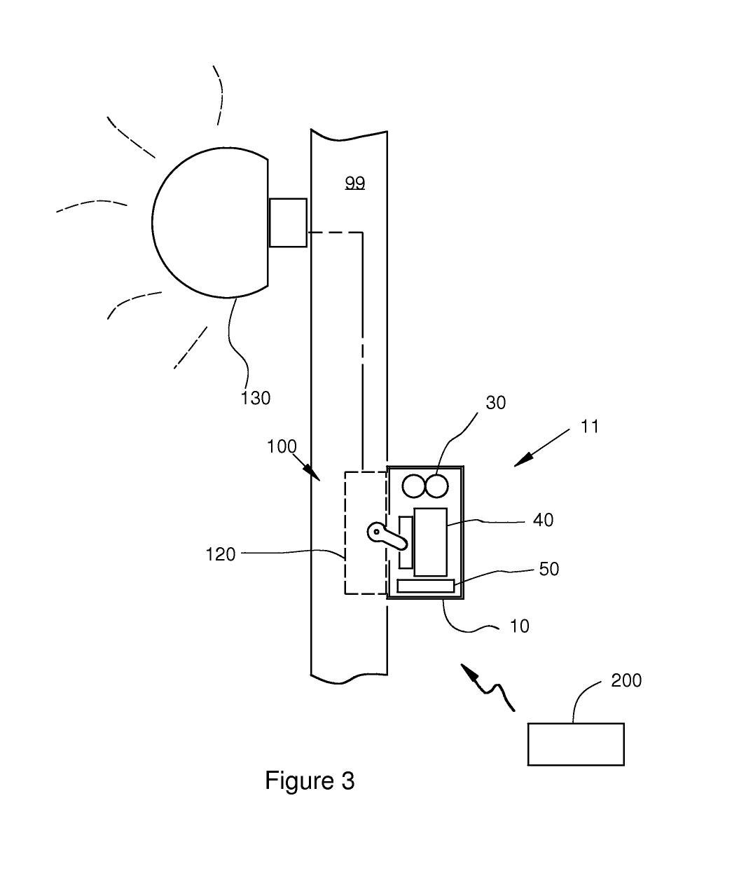

FIGS. 2 and 3 illustrate one embodiment of the inventive light flashing system 11 (for convenience herein, “LFS”) mounted over a conventional wall-mounted electrical switch. FIG. 2 is a view perpendicular to the face of the associated wall 99 in which the conventional wall-mounted switch 100 is located. FIG. 3 is a side edge view of the associated wall 99 and the wall-mounted switch 100 and the FLS 11.

The FLS 11 includes a housing 10 that is configured to be place over, or on and secured to, the wall-mounted switch. In FIG. 2, the outline of the conventional switch is illustrated in dashed line. For preferred configuration and function, the housing 10 should be approximately the same size and dimensions of the wall-mounted switch and provide means for securing the housing 10 to the wall-mounted switch. Preferably, the means for securing are elongated threaded fasteners 12 that may be received and secured to mating existing fastener elements in the wall-mounted switch. A critical objective and function of the inventive system is enabling installation with respect to an existing wall-mounted electrical switch with a minimum of effort, no alteration of the wall-mounted switch, and with no alteration or contact with the electrical power conductive elements within the switch.

FIG. 3 depicts the engagement of the FLS 11 with the wall-mounted switch. The details and particulars of the wall-mounted switch illustrated in FIG. 3 are used for example only and the invention is not limited to use with such designs. The wall-mounted switch 100 may include or be secured in a standard electrical box 120 secured within the associated wall 99 as is required in most governing construction codes, although such is not required for operation of the invention. The electrical box 120 does provide a convenient physical base for securing the inventive housing 10 and usually provides receptacles for threaded fasteners through which the housing 10 may be conveniently secured. Thus, the housing 10 is secured to the wall over, and covering, the wall-mounted switch preferably by means of securing to an electrical box 120 or the like. Most typically, conventional electrical boxes are covered by a cover plate for reasons of esthetics and safety. To enable better access to the switching elements of the wall-mounted switch and access to the securing elements, any switch cover plate should be removed prior to installation of the housing 10.

The function of the housing 10 is primarily to contain, secure and protect the operable elements of the FLS 11. These include a power supply 30, a communication system 50 and a switching system 40 as described above. It should be critically noted that the engagement between the switch system 40 and the wall-mounted switch 100 is entirely mechanical. While there may be electrical interaction between the individual components of the inventive system, these are contained within the housing 10 and there is no physical electrical connection with the wall-mounted switch or any connected electrical system.

As discussed above, FLS 11 operates to repeatedly move the mechanical actuating elements of the wall-mounted switch 100 between “on” and “off” conditions (up and down in the figure). In the configuration shown, the switch 100 includes an actuator in the form of a rigid toggle element extending from the electrical box 120 and outward from the wall 99. Elements of the switching system 40 physically engage with the toggle when the FLS 11 is installed. By “engage”, it is meant that the elements of the switching system 40 contact the actuator, or are placed in sufficiently close position, that operation of moving elements of the switching system 40 will inevitably control the movement and position of the actuator (toggle). Operation of the switching system 40 moves the toggle in up and down directions to control the switch 100. Other wall-mounted switch types and forms may have different forms of mechanical actuator, as discussed previously, and the details of the engagement of the switching system 40 and the switch actuator may differ depending on these aspects. For example, some actuators and wall-mounted switches may be controlled according to the invention as a result of inward motions (relative to the switch 100) or rotational motions, or lateral motions of the inventive switching system 40. While not limiting on the construction and function of the FLS 11, when used as intended, the wall-mounted wall 100 is electrically connected to an external lighting device 130 such that operating as intended will result in repeated movement of the switch actuator and hence flashing operation of the lighting device 130.

FIG. 3 depicts a remote control device 200. Operation of the remote control device 200, as discussed above, initiates operation of the FLS 11 and the flashing operation of the lighting device 130. The particular design and operation of the remote control device 200 is not critical.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. It should be understood that various changes can be made in the function and arrangement of elements without departing from the scope as set forth in the appended claims and the legal equivalents thereof. The foregoing description is intended to illustrate and not limit the scope of the invention, which is defined by the scope of the appended claims. Other aspects, advantages, and modifications are within the scope of the following claims.

1. A control device for a wall-mounted electrical light switch having a mechanical actuator with on and off positions, the control device comprising:
a housing configured to be mounted over and covering a light switch having a mechanical actuator;
a switching system and a communication system, both contained in the housing;
the switching system configured to engage the actuator and move the actuator into, alternatively, the on and off positions;
the communication system configured to communicate with a remote control device; and
a power supply within the housing and connected to the communication system and switching system; such that,
the communication system may receive a signal from a remote control device and thereby actuate the switching system such that the switching system actuates the light switch between the on and off positions.

2. A device according to claim 1 wherein: the switching system moves actuator alternately in a up and in a down direction.

3. A device according to claim 1 and further comprising:
a remote control device configured to communicate with the communication system.

4. A control device for a wall-mounted electrical light switch having a mechanical actuator with on and off positions, the control device comprising:
a switching system configured to engage the actuator and enabling moving the actuator into, alternatively, the on and off positions;
a communication system configured to communicate with a remote control device; and
a power supply within the housing and connected to the communication system and switching system;
the switch system, communication system and power system configured to be secured to a building wall while engaging the actuator, such that:
the communication system may receive a signal from a remote control device and thereby actuate the switching system such that the switching system actuates the light switch between the on and off positions.

5. A method of controlling a wall-mounted light switch with a mechanical actuator, comprising:
securing a switching system to a wall surface and covering a wall-mounted switch;
engaging a mechanical actuator of the switch;
receiving a control signal from a remote location;
causing the switching system to move the mechanical actuator, alternately, into on and off positions.
